(19) United States
(12) Patent Application Publication
(10) Pub. No.: US 2026/0257144 A1
(43) Pub. Date: Sep. 3, 2026

(54) TIMER SIGNALING SYSTEM AND METHODS

(71) Applicant: Achieve Equine LLC, Delano, MN (US)

(72) Inventors: James R. Chiapetta, Delano, MN (US); Sharon Camarillo, Acampo, CA (US)

(73) Assignee: Achieve Equine LLC, Delano, MN (US)

(21) Appl. No.: 19/652,614

(22) Filed: Apr. 20, 2026

Related U.S. Application Data
(63) Continuation of application No. 18/614,072, filed on Mar. 22, 2024.
Application No. 18/614,072 is a continuation of application No. PCT/US2022/044270, filed on Sep. 21, 2022.
(60) Provisional application No. 63/248,625, filed on Sep. 27, 2021.

(51) Int. Cl. A63K 3/00

(52) U.S. Cl. CPC A63K 3/00

(57) ABSTRACT

Competition timing systems are disclosed. In a competition in which a task is to be completed, a triggering event indicating beginning or completion of the task is determined by sensing disconnection of a connection component, or removal of a sensed component from proximity to a sensor. The automated timing that can then be generated allows human error and human judgment to be removed as variables from the race timing.

### CROSS REFERENCE TO RELATED APPLICATIONS

The present application is a continuation of U.S. Patent Application No. 18/614,072, filed Mar. 22, 2024, which is a continuation of PCT Application No. PCT/US2022/044270, filed Sep. 21, 2022, which claims the benefit of and priority to U.S. Provisional Patent Application No. 63/248,625 filed Sep. 27, 2021 and titled TIMER SIGNALING SYSTEM AND METHODS, the disclosures of each are incorporated herein by reference.

### BACKGROUND

Event timing using human interaction can introduce error in a variety of ways. In competitive and fast-occurring events, the human interaction with a timer introduces inaccuracy. Examples include equestrian sports such as roping, including team roping, calf roping and/or breakaway roping. Each of these events are examples of sports that rely on humans to manually start and stop the timer. For these and other events, timing often relies on a judge or flagger who sees an indication or action that causes them to start or stop the clock by activating a button or signaling yet another person to start or stop the clock. Equestrian events are just an example, and similar issues arise in various contexts.

In some such events, the time differences between competitors may be in the tenths of seconds or less. Human errors and/or variations in the response time of the judge or flagger can therefore have a significant impact on race outcomes. New methods and/or systems to enhance event timing precision for human or animal events are desired.

### OVERVIEW

The present inventors have recognized, among other things, that a problem to be solved is the need for new and/or alternative ways to determine when a race task is completed. One particular context is that of equestrian events, such as roping.

A first illustrative and non-limiting example takes the form of a first connection component for use in timing an equestrian sporting event comprising: a mounting region for mounting the first connection component to a horse competing in the equestrian sporting event; a connection region configured to connect with an end of a rope used in the equestrian sporting event; a sensor for detecting disconnection of the end of the rope from the connection region; and a control circuit configured to receive a signal from the sensor indicating disconnection, and to perform an action in response thereto.

Additionally or alternatively, the invention may be a timing system for an equestrian event, comprising the first connection component of the first example, and a second connection component secured to the end of the rope, wherein the connection region of the first connection component connects to the end of the rope via the second connection component by releasably engaging with the second connection component, further wherein the sensor is configured to detect disconnection of the end of the rope when the second connection component is disengaged from the first connection component.

Additionally or alternatively, the second connection component, when connected to the first connection component, either: completes an electrical circuit such that the sensor detects disconnection by detecting breaking of the electrical circuit; or breaks an electrical circuit such that the sensor detects disconnection by detecting making of the electrical circuit.

Additionally or alternatively, the connection region comprises first and second electrical components, and the sensor detects movement of the first and second electrical components into proximity with one another, or out of proximity with one another, to detect disconnection of the end of the rope.

Additionally or alternatively, wherein the sensor includes first and second optical components, and the sensor detects disconnection in response to coupling or decoupling of the first and second optical components.

Additionally or alternatively, the sensor includes a magnet and a magnet detector, and the sensor detects disconnection in response to coupling or decoupling of the magnet and magnet detector.

Additionally or alternatively, the first connection component comprises a first communication circuit coupled to the control circuit and configured for generating communication signals in response to the control circuit.

Additionally or alternatively, the invention may be a timing system for an equestrian sporting event, comprising the first connection component of preceding examples, and a system timer configured to receive a signal from the first communication circuit, and determine, from the signal, a start or end time of a participant in the equestrian sporting event.

A second illustrative and non-limiting example takes the form of a rope for use in a rodeo event, the rope comprising: a first end having a first connection component that is configured to connect with a second connection component mountable to a horse such that, when the first connection component is connected to the second connection component, disconnecting the first connection component from the second connection component causes the status of a timer timing the rodeo event to change status from a first status to a second status; and a second end.

Additionally or alternatively, the first connection component is detachable from the first end of the rope.

Additionally or alternatively, the first connection component is integral with the first end of the rope.

Additionally or alternatively, the first and second connection components are configured to disconnect in response to a pulling force applied to the rope.

Additionally or alternatively, the rope may further comprise a detector coupled to the first connection component and configured to detect coupling or decoupling of the first connection component to the second connection component; and a transmitter adapted to transmit a signal to the timer to change the status from the first status to the second status in response to a change identified by the detector.

A third illustrative and non-limiting example takes the form of a timer for timing an equestrian sporting event comprising: a clock for timing the equestrian sporting event; a receiver for receiving a signal transmitted to the timer; and a controller for calculating a time elapsed during the equestrian sporting event; wherein the signal transmitted to the timer is transmitted when a first connection component attached to a rope used in the equestrian sporting event is detached from a second connection component, the second connection component adapted to couple to the first connection component.

Additionally or alternatively, the timer system may further include a transmitter, the transmitter being coupled to a detector configured to detect detachment of the first connection component from the second connection component.

Additionally or alternatively, the timer is configured to calculate a time elapsed during the equestrian sporting event from a start time to an end time; and the timer is configured to use a signal received by the receiver from the transmitter to determine at least one of the start time and the end time.

This overview is intended to introduce the subject matter of the patent application. It is not intended to provide an exclusive or exhaustive explanation. The detailed description is included to provide further information about the present application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a connection component for an illustrative example;

FIG. 2A shows a rope having a connection component attached thereon;

FIGS. 2B-2H show several illustrative rope connectors;

FIG. 3 shows an illustrative example;

FIG. 4 shows an illustrative saddle with a rope and race timing apparatus;

FIG. 5 shows a sensor coupled to a rope and a race timing apparatus; and

FIG. 6 shows an illustrative method in block form.

### DETAILED DESCRIPTION

Various automated timing and threshold crossing methods are known. An electronic “eye” for example may use an emitter and a receiver to pass an optic beam parallel to a threshold. A common household use is as a safety mechanism for a garage door opener, in which the electronic eye is used to ensure that the path for the garage door to close is not obstructed, and similar technology has been used for race and other event timing as well. When an obstruction interrupts the optic beam, the receiver notes the interruption of the beam and identifies the physical intrusion. For a footrace, for example, an electronic eye can determine when the finish line is crossed. The electronic eye can be coupled to a camera that captures an image of the finish line being crossed to aid determination of who won in a race having multiple simultaneous competitors. Barrel racing, in the rodeo context, may rely on the use of an electronic eye to automatically detect crossing of the start or finish line.

Race chips and mats are also known. A race chip can take the form of an RFID tag carried in a wrist or ankle wrap. A common use is in triathlon and distance running competitions. One or more mats are placed at locations along the course, including the start line, finish line, and intermediate points of interest (halfway point, or a transition zone between events of the triathlon, for example). When the competitor goes over the mat, the RFID tag is detected, allowing the race system to determine the time at which the competitor crosses over the mat.

However, for a competition that lacks a fixed start or finish line location, these known electronic eye and/or race chip/mat solutions are not useful. In addition, some events are not amenable to starting and/or stopping the event clock using, for example, an electronic eye, because the action that triggers the clock starting may not occur at a single location or may not be well suited to detection by an electronic eye. Accordingly, new and alternative solutions are desired.

Some embodiments are directed to a system for timing a sporting event with a higher level of precision than currently available. In some examples, the sporting event may be an equestrian or rodeo event. In an example, the system can be used to time a roping or breakaway roping event.

Breakaway roping is a timed rodeo event, and is a variation of calf roping where a calf is roped, but not thrown and tied. In breakaway roping, a calf is released from a chute. The competitor, sitting on his or her horse, waits behind a barrier in an area referred to as a box. When the calf gets enough distance from the chute the barrier is released, and the competitor and horse exit the box to chase the calf. The competitor throws a first end of a rope over the calf’s neck, with a second end of the rope attached to the saddle by a small string and a flag. When the first end of the rope is looped around the calf’s neck, the rider stops the horse and the calf continues to run. Once the calf’s distance to the horse exceeds the length of the rope, the small string breaks, releasing the flag and the second end of the rope from the saddle. Event timing relies on a judge or flagger, who sees the flag released and activates a button to stop the event clock.

Components of a system of the disclosure, according to an example, include a timer running a clock, a rope and components that change the status of the clock, whether by stopping a running clock or starting a stopped clock. According to the example, when the calf is caught by a first end of the rope being looped around the calf’s neck, the rider stops the horse abruptly causing the rope to tighten as the calf continues to run. According to an embodiment, the connection component may releasably connect to the second end of the rope and, when the force of the connection is overcome, the connection component detects disconnection. In various examples, the connection component may issue a signal indicating that the disconnection has taken place, causing a timer to stop running remote from the connection component. In another example, the connection component comprises a clock, and stores a time at which the disconnection occurs, with that time then communicated to the event system. Either way, stopping the clock is not dependent on the reaction time of a human judge or flagger.

In some examples, the connection component includes a first part that secures to the rope, and a second part that is affixed to the rider’s animal, such as by securing to the saddle thereof; the first and second parts may be referred to herein as first and second connection components. In other examples, a connection component is releasably secured to the rope at the second end thereof, and holds the rope until sufficient force is supplied to pull the rope out of the connection component. With either form, the connection component is configured to identify when the rope has been released with more precise and reliable outputs than relying on a human judge.

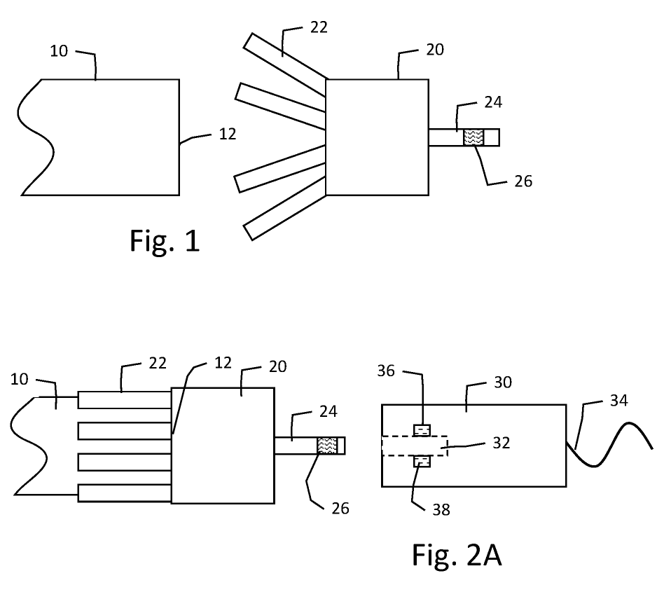

FIG. 1 shows a first connection component 20 for an illustrative example. In FIG. 1, a rope 10, which can be the rope used for lassoing the calf in a competition such as breakaway roping, may have a loop formed at its first end (not shown) and is coupled at its second end 12 to a first connection component 20. The first connection component 20 includes a plurality of teeth 22 that can be secured to the second end 12 of the rope 10, such as by crimping, to form a secure physical connection. The first connection component further includes, for example, a pin 24 having a conductive surface 26. In other examples, rather than using a connection component 20 that is crimped onto the second end 12 of the rope 10, the connection component 20 may instead be a pin that is mounted to a strand of wire or rope which is intertwined in the weaving of the rope at the time of manufacturing of the rope. In other examples, the connection component may be attached by other methods including the use of a melted plastic, application of an adhesive, or any other suitable attachment.

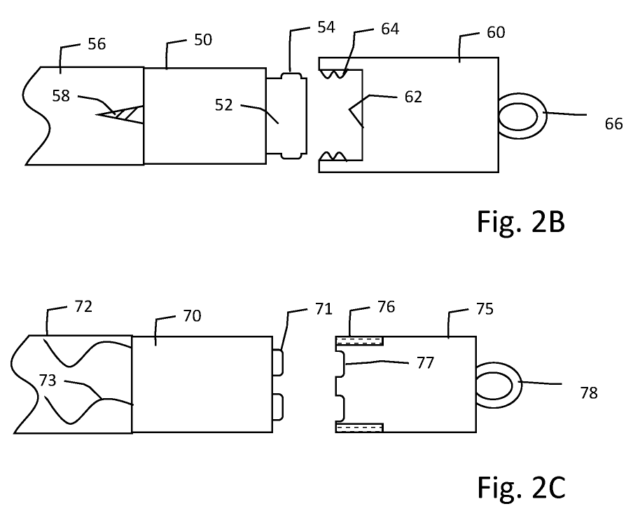

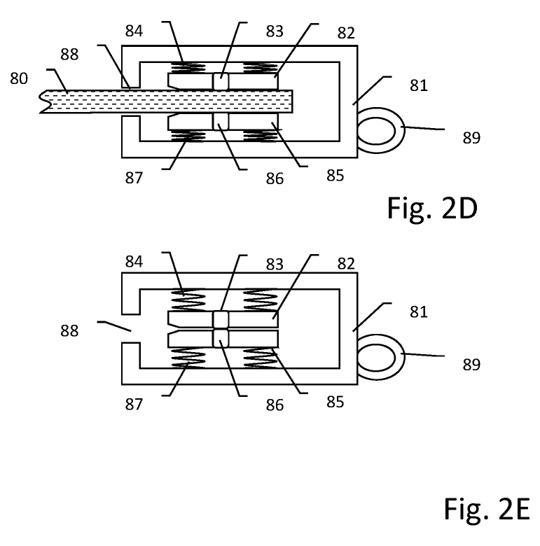

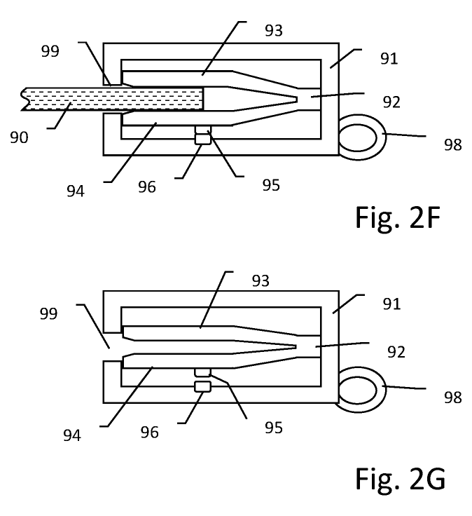

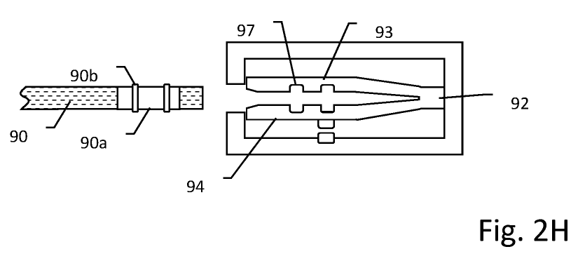

FIG. 2A shows a rope 10 having a first connection component 20 attached thereon. Here, the second end 12 of rope 10 is now coupled to the first connection component 20, with teeth 22 shown in a crimped position (noting again that a range of other suitable approaches for securing the first connection component 20 to rope 10 may be used), securing the first connection component 20 to the rope 10. A second connection component 30 is also shown. The second connection component 30 is configured to receive the pin 24 in a bore or slot 32. The second connection component 30 includes a tether 34 that may in turn be attached to the saddle, for example. The tether 34 may be used as a safety mechanism to allow detachment of the entire apparatus in the event that the pin 24 does not readily remove from the slot 32, optionally. While FIG. 2A shows a pin on the first connection element 20 and the slot 32 on the second connection component 30, the positions may be reversed relative to the rope 10 and the tether 34.

The receptacle 30 may include seal rings, metal or plastic springs, a collet, or bracket, etc., for receiving the pin 24 and applying some degree of retention force. Retention force may instead be a magnetic force, such as by incorporating a magnet in one or the other of the connection component 20 or the receptacle 30. For example, a pull force of at least 1, 2, 3, 4, 5, 10, or more Newtons may be required to pull the pin 24 from the receptacle 32.

The slot 32 may include electric contacts 36, 38 on opposing sides of the slot 32, with the receptacle 30 including electronics configured to sense impedance between the electrical contacts 36, 38. When the pin 24 is not present in the slot, the sensed impedance will be much higher than when the pin 24 is present, as the conductive surface 26 will present a low impedance interface. Removal of the pin 24 can therefore be detected readily by the electronics.

In an alternative, the pin 24 may have two or more conductive regions that are separated from one another. Insertion of the pin 24 to a slot having a conductive ring therein would then complete the circuit for the two conductive regions, allowing the connection component having the ring to detect/sense the placement of the pin 24 in the slot, if desired.

In another example, rather than using impedance sensing, the system includes a magnet on the first connection component 20, at the location shown by 26. Element 36 and or 38 of the second connection component 30 may take the form of a magnet sensor, such as a Hall effect sensor or Reed switch, a magneto-resistor, or any other suitable magnet sensor. When the first connection component 20 is coupled to the second connection component 30, the magnet sensor 36/38 senses the proximity to the magnet 26. When the first connection component 20 is removed from the second connection component 30, the magnet sensor 36/38 will no longer sense the proximity to the magnet 26, and an electrical characteristic (conductance, resistance, etc.), or an output of the magnet sensor 36/38 changes and is sensed by circuitry in the second connection component 30. As a result, when the connection components are disconnected from each other, the magnet sensor detects the disconnection.

FIGS. 2B and 2C show further examples. In FIG. 2B, a first connection component 50 has an extension 52 which carries a ring 54. The second connection component 60 includes a bore 62 into which the extension 52 can be placed. A spring 64 is provided for holding the extension 52, with the aid of the ring 54. The spring 64 may comprise two or more conductive portions that electrically couple to the ring 54 to allow impedance sensing to be used to determine when the first connection component 50 is removed from proximity to the second connection component 60. Either connection component may be attached to a rope, with the other connected to a tether for example and then to a saddle, or to another part of the horse’s body or tack, as desired. In the example shown in FIG. 2B, the connection component at 50 is attached to a rope 56 with the use of a screw 58 that screws into the rope 56. To augment such a screw-type connection, a band may be placed about the end of the rope 56 over the screw, if desired. The second connection component 60 has a ring 66 attached thereon, to which a strap, rope, carabiner, or other tether may be attached to secure to the horse/saddle/tack. Such a ring may serve as a mounting region for mounting the connection component 60 to a horse competing in an equestrian event, or for mounting to a calf or other animal in the sporting event.

In this example, and throughout this disclosure, the connection component that is attached to the horse/saddle tack is alternatively illustrated as having either a tether or a ring for attachment. It will be appreciated that the purpose is to facilitate simple attachment of the connection component to the horse/saddle tack. According to various embodiments, any suitable system or structure for attachment of the connection component to the horse/saddle tack may be used, including straps, belts, clamps, etc. made from suitable fabric, metal, plastic, rubber, combinations thereof, or other materials.

FIG. 2C shows another example. Here, the first connection component 70 has a plurality of pins or posts 71 adapted for extending into slots 77 on the second connection component 75. The second connection component also includes one or more magnets 76 (the magnets may instead be on the first connection component 70, if desired). The magnets 76 provide a retention force to hold the two connection components together, in place of or in addition to any mechanical forces supplied by for example a spring or other structure (not shown in FIG. 2C). The posts 71 may be conductive and/or may have a conductive wire extending therebetween, with corresponding electrical contacts in the slots 77 for use in impedance sensing. Such impedance sensing may be used to detect connection and/or disconnection of the first connection component 70 to the second connection component 75. The posts 71 and slots 77 may also aid in secure registration of the two connection components 70, 75. The second connection component 75 has a ring 78 attached thereon, to which a strap, rope, carabiner, or other tether may be attached to secure to the horse/saddle/tack.

In the example shown in FIG. 2C, one or more strands, wires, or threads 73 extend into the rope 72, such as by weaving into the rope material during manufacturing. The strands, wires or threads 73 are then used for securing the first connection component 70 to the rope 72. The configurations shown in FIGS. 2A-2C show the male connector of the two connection components is attached to the rope. This placement may be reversed, if desired, and the female connector of the two connection components may be the one attached to the rope, if desired.

FIGS. 2D and 2E show another example. In this example, as shown in FIG. 2D, a rope 80 is shown received through opening 88 in a connection component 81 that has a first coupler 82 and a second coupler 85. The connection component 81 may include a ring, as shown at 89, to which a strap, rope, carabiner, or other tether may be attached to secure to the horse/saddle/tack. The first coupler 82 carries a first conductive element 83, and is pressed inward, toward the rope 80 by one or more springs 84. The second coupler 85 carries a second conductive element 86, and is pressed inward, toward the rope 80, by one or more springs 87. The inner, rope facing surfaces of the first and second couplers 82, 85 may carry teeth, bumps, ridges, or may be roughened, to create friction against removal of the rope 80 through the opening 88. The springs 84, 87 provide force to hold the rope 80 in place using such friction.

When the rope 80 is pulled with sufficient force, it is drawn through opening 88 and removed as shown in FIG. 2E. With the rope no longer present, the springs 84, 87 push the couplers 82, 85 together as shown until the conductive elements 83, 86 come together and form a connection. A sensing circuit (not shown) may be electrically coupled to each of the conductive elements 83, 86 and detect when direct physical connection is made using any suitable circuitry for sensing an electrical connection. Rather than direct physical connection, close proximity may be sensed instead, such as by sensing for a change in capacitance between the two conductive elements 83, 86, in which case one or the other or both may be coated with a dielectric, preventing corrosion. When the conductive elements are close to one another, they form a rough plate capacitor, and the sensing circuit may apply a time varying signal thereto such that, when the conductive elements 83, 86 come together, the impedance therebetween changes and the sensing circuit will identify the change.

In an alternative configuration, the device of FIG. 2D may instead have optical elements at 83 and 86, where one is an output device and the other is a receiver. With the rope 80 in place, an optical output (such as from an LED at 83) cannot be sensed at the receiver (such as a light sensitive device, for example an opto-resistor or optical detector). When the rope 80 is removed by overcoming the friction forces described above, the optical signal is sensed at the receiver, triggering a signal that indicates the rope has been removed. In still another example, item 83 may be a magnet, such as a permanent magnet, and item 86 may be a magnet sensor, as described above, and the sensing circuit may monitor an output or characteristic of the magnet sensor to detect proximity between 83 and 86.

FIGS. 2F and 2G show another example. In FIG. 2F, the rope 90 is received via opening 99 in a connection component 91 that has a coupler 92 in the form of a spring assembly, similar to a collet. The connection component 91 may include a ring, as shown at 98, to which a strap, rope, carabiner, or other tether may be attached to secure to the horse/saddle/tack The coupler 92 has at least a first arm 93 and a second arm 94. On the outside of the second arm 94 is an electrical connector 95. With the rope 90 inserted between the arms 93, 94, the first electrical connector 95 comes into contact with a second electrical connector 96. The inside of each arm may have teeth, bumps, or a roughened or textured surface to increase friction relative to the rope 90, and are spring biased against the rope when the rope is positioned as shown. When the rope is pulled out of the connection component 91 via opening 99, as shown in FIG. 2G, the arms 93, 94 move, in response to spring bias, toward one another, drawing the first electrical connector away from the second electrical connector, and breaking a circuit that includes the two electrical connectors 95, 96.

One advantage of the examples in FIGS. 2D-2G is that the ropes can be unmodified, as nothing mechanical or electrical needs to be carried by the rope. If desired, rather than optical or electrical signal sensing, magnetic sensing may be used in these designs, as previously described.

In FIGS. 2D-2E, the presence of the rope breaks an electrical circuit, and the sensor senses disconnection of the rope from the connection component 81 when the electrical circuit is completed. In FIGS. 2A-2C and 2F-2G, the presence of the rope and/or second connection component completes an electrical circuit, and the sensor senses disconnection of the rope when the electrical circuit is broken.

FIG. 2H shows another example, similar to FIGS. 2F-2G. Here, the rope 90 carries a connection component 90a, having protrusions thereon as shown at 90b. The protrusions 90b are sized and spaced to interact with indents 97 on the first and second arms 93, 94 of the coupler 92. In this example, rope 90 would be held in place at least partly by the interaction of the protrusions 90b with the indents 97. In other respects the example of FIG. 2H is similar to 2F and 2G. Such protrusion/indent combinations may also be used in the example of FIGS. 2A, and/or 2C-2E, if desired.

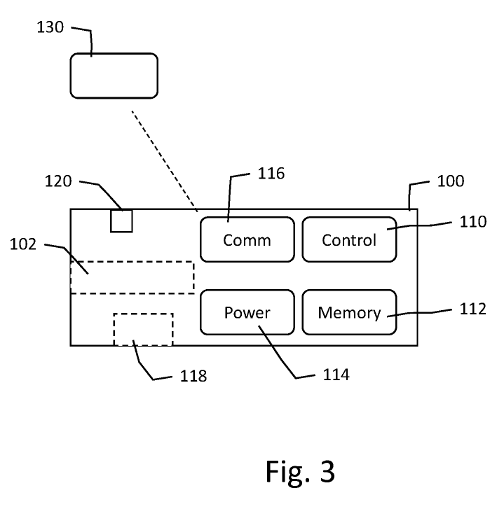

FIG. 3 shows an illustrative connection component including electronics that may be used for detection of removal of a rope from the connection component, whether that rope carries a connection component itself or not. Here, the connection component 100 includes a slot 102, making the connection component a receptacle or female coupling in the example shown. In other examples, rather than a slot or receptacle, a pin, posts, etc. if desired and as noted above, may be provided on the connection component. A control circuit 110 is provided and electrically coupled to the slot 102 (or pin, or magnet sensor, or optical component, as the case may be) to sense the presence and then absence of a second connection component mating with the connection component 100 that is shown. The control circuit may include suitable discrete electronics for such sensing (such as one or more operational amplifiers, comparators, flip-flops, etc.), and/or may include a microcontroller. In some examples a microcontroller is used as control block 110 and includes a circuit clock, such as a crystal oscillator and associated circuity as are known in the art, so that the connection component 100 can determine for itself when events take place. The control circuit 110 may, for example, be as simple as an automatically responding set of logic that triggers an action, such as a communication to another device (such as a system timer) or storage of a time stamp in response to sensing decoupling of the first and second connection components; in other examples, the control circuit 110 may include more sophisticated electronics such as a state machine, a microcontroller, a microprocessor, an application specific integrated circuit (ASIC), a field programmable gate array (FPGA), etc. allowing configuration, programming, and/or reconfiguration of the functions thereof.

A memory 112 may be provided to store instructions for operation of the microcontroller (if provided) as well as to store data related to detected events. For example, on disconnection from a second connection component, the controller 110 may store a timestamped data in the memory 112 for later retrieval. The memory 112 may be removeable or may have a removeable component or a connection for receiving a removeable component, such as by the inclusion of a USB port (of any desired standard level/type), or an SD/micro-SD card port, for example and without limitation.

The connection component 100 further comprises a power source 114, such as a removeable battery, rechargeable battery, capacitor, or other power source. The power source may be rechargeable by including a port 118, such as a micro-USB port or a port for receiving an AC adaptor pin, such as a 5V supply, allowing the power source 114 to be charged prior to use. If a port is provided, such a port may also be usable to offload data or load programming data to the memory 112, as desired.

For descriptive purposes, in some examples using first and second connection components, the connection component that is configured to sense removal of the other connection component may be referred to as the sensing connection component, and the other connection component may be referred to as the removable connection component. The sensing connection component may be coupled to the rope or to the saddle, as desired. In some examples, such as for breakaway roping, it may be preferred that the removable connection component be the one that is coupled to the rope, as retrieval of the rope may require chasing down the calf after the competition is completed. Since the calf will keep running after being roped (due to the rope being released), the rope itself is subject to potential wear and damage as it is dragged over various surfaces. Therefore, it may be desirable that the sensing connection component stay attached to the saddle/horse, rather than being secured on the rope. For examples where a single connection component determines removal of a rope, as in FIGS. 2D-2G, the single connection component may be the sensing connection component and, by design, such a system would have the sensing connection component attached to the saddle/horse.

A communications circuit is also provided at 116. The communications circuit 116 may use any suitable wireless communications mode, such as, for example and without limitation, Bluetooth™, WiFi, the ISM band, RF communication, cellular, and/or any of the various IEEE 802 wireless communications modes, as desired. Communication may be to a remote device which may be, for example, connected to a race timing system 130 used to display the timing results obtained from the device.

In some examples, the communications circuit 116 is triggered as soon as disconnection is detected, and the race timing system 130 detects the communication from the connection component 100 to stop the race/timing clock. A circuit clock may be omitted from the connection component 100, if desired. For example, the time at which a communication is received by the race timing system 130 may stop the race timing clock. In other examples, the communications circuit 116 communicates a data packet including each of a current time stamp and a time stamp indicating when, relative to the clock for the connection component 100, disconnection was observed. The race timing system 130 can then use the two communicated time stamps to determine, relative to the race clock, when the disconnection in fact occurred.

The race timing system 130 may also record the time at which the event started. For example, in breakaway roping, the race timing system 130 may rely on an electronic eye or an RFID race mat, described above, to record a time at which the contestant crossed the start barrier. In another example, a similar combination of a sensing connection component 100 and a removeable connection component may be used to sense the time as which the start barrier was removed/released. For example, the start barrier rope may be secured on one end using a combination of a sensing connection component and a removeable sensing component, and is released by removing the removeable sensing component from the sensing connection component, as by pulling on the barrier rope.

If desired, a light 120 or other indicator (including audible indicators such as a bell, tone, whistle, voice, etc.) may be provided on the connection component and may provide any of several indicators, including “Not Connected,” or “Error” (such as by having a yellow or red output), “Ready” (such as by showing a green output), and/or any other suitable or desired indications. In some examples, the light 120 can be used to ensure that everything in the system is operational before the use, including that the internal circuitry is powered and ready, and that the sensing connection component detects the removable connection component.

In an illustrative example, an event timing system may operate as follows. The “start” of the event may be triggered by human interaction, that is, by the pressing of a button for example. The start of the event may instead be automatically triggered, as by simultaneously issuing an external alert (a light, an audible sound, etc.) to the racer that the event has started along with recording a time stamp associated with the alert. The start may also be triggered by the detection of an action, such as the crossing of a timing mat, or by an action that makes, breaks, or interrupts an electric, optical (electronic eye), or magnetic connection, for example. The opening of a gate, in a roping or riding event, for example, may occur with a sensor attached to the gate to detect when the gate is opened by breaking or making an electric circuit, generating or interrupting an optical signal, or causing a magnet to be sensed or no longer sensed due to the physical movement of the gate. Similarly, if a rope is attached to a calf or other animal, the rope may include a connection as shown above that can be used to determine whether and when the animal has crossed a threshold, such as pulling the rope tight, causing a connection component to release, with such action making or breaking an electric circuit or magnetic connection or other detectable event. An electronic event timing system can record the start time using a time stamp based on the internal clock of the electronic event timing system.

The event end time can be determined as well, such as by the making or breaking of an electric, magnetic, optical or other connection. For example, removal of the removable connection component from the sensing connection component, as described above, may be used. The electronic event timing system can record the end time using a time stamp also based on the internal clock of the event timing system. The actual time of the event can then be determined by the electronic event timing system comparing the recorded time stamps for the start and end of the event, such as by subtraction.

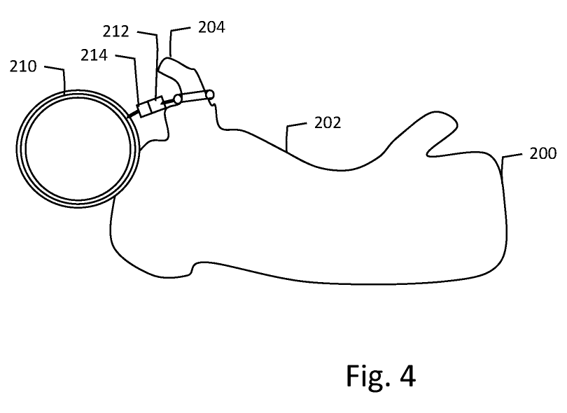

FIG. 4 shows an illustrative saddle with a rope and race timing apparatus. The saddle 200 would be placed on the competitor’s horse, and is shown with a seat 202 and a horn 204. The competitors rope 210 is shown, and is connected to the saddle 200 with the first and second connection components 212, 214. When the rope 210 is used by the competitor to capture a calf, for example, the connection components 212, 214 will disconnect, and whichever of the connection components has the circuitry will provide an indication of when the disconnection took place.

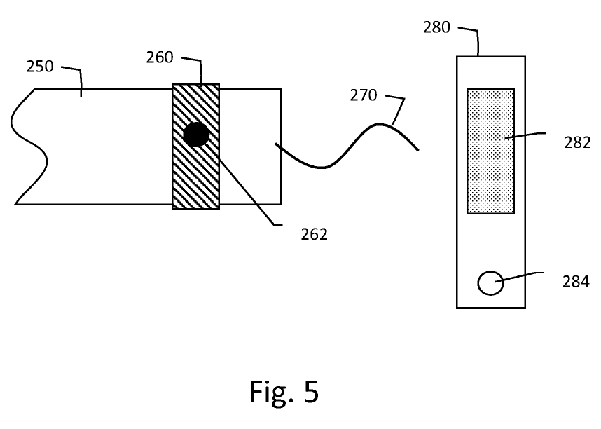

FIG. 5 shows another example. In this example, the rope 250 carries a band 260 thereon, with the band 260 including a magnetic component and/or an RFID tag 262. A lightweight string 270 connects the rope 250 to a saddle (not shown). A detector station 280 is provided to sense proximity to the band 260. The detector station 280 may include several of the same circuit elements as discussed above in FIG. 3. Here, however, rather than using impedance at the slot as in FIG. 3, the detector 280 includes a sensor 282 that senses proximity to the magnetic component and/or RFID tag 262. A light 284, optionally, indicates to the user that the proximity to the magnetic component and/or RFID tag 262 has been sensed. When the competitor successfully ropes a calf in the event, the rope 250 pulls away, breaking the string 270 and pulling the magnetic component and/or RFID tag 262 away from the sensor 282. The detector 280 identifies the failure of the sensor 282 to sense proximity to the magnetic component and/or RFID tag 262, and issues a communication and/or records a time stamp. In an example, the light 284 will also change once the magnetic component and/or RFID tag 284 is no longer present, such as by turning from on to off, or changing colors such as from green to yellow or red.

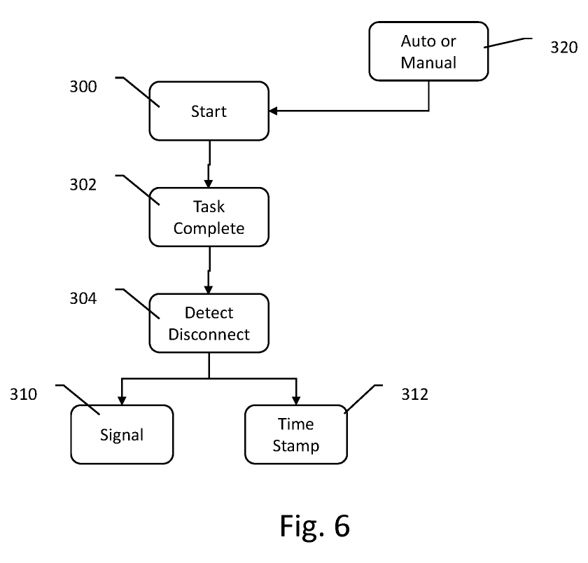

FIG. 6 shows an illustrative task flow in block form. A start block 300 initiates the task. Once the underlying task is completed at 302, the connection apparatus detects disconnection at 304. The underlying task 302 may be, for example, roping a calf, and disconnection at 304 occurs as the calf runs away from the competitor, breaking the connection using any of the above described examples. An output is then generated, such as by generating a signal 310 indicating completion of the task. A time stamp 312 may also be recorded, as desired. As shown, the start block 300 may be automatically or manually triggered 320. For example, the competitor, or an animal (such as a calf) that the competitor is to rope or overtake, may cross a line and the line crossing can be detected by an RFID tag or optical sensor, which can generate its own time stamp, as desired. As noted, the start block 300 may instead be automatically triggered when a sensing connection component senses removal of a removeable connection component. By calculating the time between a time stamp associated with line crossing 320 and that at 312, the system can determine the race time for the competitor to complete the task 302.

In some embodiments, the system of the disclosure may alternatively be used to start a timer clock. For example, in tie down roping, a calf enters a chute, a door is closed behind the calf and a trip rope is attached to a trip lever that is secured around the calf’s neck. The lever attaches to a barrier cord that runs across a pen or "box" that is on one side of the calf chute, where the horse and rider wait. When the rider is ready, she calls for the calf, and the chute operator pulls a chute lever that opens the chute doors to release the calf. The calf runs out of the chute with the trip rope. When the calf reaches the end of the trip rope, the trip lever is pulled causing the rope to fall off the calf, and the barrier cord is released, allowing the horse and competitor to exit the box. In one embodiment, the end of the trip rope can include a first connection component that removably mounts to a second connection component that mounts to the chute to trigger the timer clock. In an embodiment the end of the trip rope can include two “tails,” one that includes the connection component to trigger the clock and the second tail configured to attach to the trip lever to release the barrier cord for the horse to exit the box.

In an embodiment, the barrier cord on the box can have a first end with a first connection component that removably mounts to a second connection component mounted to the box. In this embodiment, when the rider is ready, she calls for the calf, and the chute operator pulls a chute lever that opens the chute doors to release the calf. The calf runs out of the chute with the trip rope. When the calf reaches the end of the trip rope, the trip lever is pulled causing the rope to fall off the calf, and the barrier cord is released by a pull that is of sufficient force to disconnect the first connection component from the second component which detects the disconnection of the first connection component and start the timer clock.

In some examples, the use of an automated timing apparatus to determine the start of the event may also be used to detect any false start by the competitor. For example, first and second sensing devices may be used, with a first sensing device on the trip rope to detect the calf reaching the end of the trip rope, and the second sensing device coupled to the barrier cord to detect when the barrier cord is released. Each of the sensing devices may be as described above, with a single connection component removeable secured to a rope, or having first and second connection components. If the event timing system determines that the barrier cord is released before the trip cord, it may be due to the rider/competitor/horse leaving the box early. The system can thus detect a false start if the barrier cord is released before the trip cord. A third sensing device may also be used to detect the completion of the underlying task, as described above, by for example sensing disconnection of the competitor’s rope from the saddle/horse when the calf is roped, or by the use of an electronic eye for events having a finish line.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A saddle timer for a breakaway roping event comprising:
a housing containing electronics; and
a strap configured for mounting the housing to a saddle;
wherein the electronics comprise a sensor configured to detect pulling of a rope away from the saddle timer.

2. A system comprising the saddle timer of claim 1, wherein the sensor is a magnet sensor, and a magnet adapted to secure to a rope.

3. The system of claim 2, further comprising a connection component, wherein the magnet is secured to the connection component, and the connection component is attached to the rope.

4. A system comprising:
the saddle timer of claim 1, the saddle timer further including a first connection component; and
a second connection component configured for connecting to a rope used in the breakaway roping event, the second connection component configured for coupling to the first connection component, wherein the sensor is configured to detect decoupling of the first connection component from the second connection component.

5. A system for timing a breakaway roping event, comprising:
the system of claim 4; and
a start sensor configured to record a start time of the breakaway roping event upon detection of a start event;
wherein the electronics in the housing is configured to detect an end time of the breakaway roping event using the sensor upon detection of an end event;
wherein the start event is a crossing of a threshold; and
wherein the end event is the pulling away of the rope from the saddle timer.

6. A system for timing a breakaway roping event, comprising:
the system of claim 4; and
a gate sensor configured to record a start time of the breakaway roping event upon detection of a start event;
wherein the electronics in the housing is configured to record an end time of the breakaway roping event using the sensor upon detection of an end event;
wherein the start event occurs at or near a gate; and
wherein the end event is the pulling away of the rope from the saddle timer.

7. The system of claim 6 wherein the gate sensor is an optical sensor.

8. The system of claim 6, further comprising a communications device configured to:
communicate with the gate sensor to determine the start time;
communicate with the saddle timer to determine the end time; and
determine an elapsed time of the breakaway roping event using the start time and the end time.

9. A system for timing rodeo events, comprising:
the saddle timer of claim 1; and
a gate sensor configured to record a start time of the breakaway roping event upon detection of a start event;
wherein the electronics in the housing is configured to detect an end time of the breakaway roping event using the sensor upon detection of an end event; and
wherein the end event is the pulling away of the rope from the saddle timer.

10. The system of claim 9, further comprising a communications device configured to:
communicate with the gate sensor to determine the start time;
communicate with the saddle timer to determine the end time; and
determine an elapsed time of the breakaway roping event using the start time and the end time.

11. A system for timing rodeo events, comprising:
a gate sensor:
a saddle sensor; and
a communication circuit in wireless communication with at least one of the gate sensor and the saddle sensor;
wherein the gate sensor is configured to record a start time of a rodeo event upon detection of a start event; and
wherein the saddle sensor is configured to record an end time of the rodeo event upon detection of an end event.

12. The system of claim 11, wherein the gate sensor is configured to detect when a gate is opened by one of:
breaking or making an electric circuit,
receiving, generating or interrupting an optical signal, or
causing a magnet to be sensed or no longer sensed due to physical movement of the gate.

13. The system of claim 11, wherein the end event includes the saddle sensor detecting one of:
a loss of a magnetic coupling between the saddle sensor and a magnetic element connected to a rodeo contestant's rope; or
breaking or making of an electrical circuit at the saddle sensor caused by pulling away from the rodeo contestant’s rope.

14. The system of claim 13, wherein the saddle sensor comprises a magnet sensor, a magnet, and a connector, and the magnet is connected to the connector, and the connector is coupled to a rodeo contestant’s rope.

15. The system of claim 14, wherein:
the rope pulls on the connector when the rope is pulled taut;
the connector pulls the magnet away from the magnet sensor when the connector is pulled by the rope; and
the circuitry records the end time by identifying a time a magnetic connection between the magnet and the magnet sensor is lost.

16. A method for timing a rodeo event, comprising:
recording a first time associated with detection of a start event for the rodeo event, wherein recording the first time includes detecting a first action that makes, breaks, or interrupts an electrical, optical, or magnetic connection;
recording a second time associated with detection of an end event for the rodeo event, wherein recording the second time is performed by a saddle sensor; and
comparing the first time and the second time to determine a total time of the rodeo event.

17. The method of claim 16, wherein recording the first time is performed by a gate sensor.

18. The method of claim 16, wherein the end event includes the saddle sensor detecting a loss of a magnetic or electrical connection between the saddle sensor and a magnetic or electrical element connected to a rodeo contestant's rope.

19. The method of claim 18, wherein the saddle sensor comprises a magnet sensor and a magnet coupled to a connector that is connected to a rope of a rodeo contestant;
wherein detection of the end event includes:
the rope pulling on the connector when the rope is pulled taut;
the connector pulling the magnet away from the magnet sensor; and
the saddle sensor identifying a time the magnetic connection between the magnet and the magnet sensor is lost.

20. The method of claim 18, wherein the saddle sensor comprises one or more electrical contacts, a connector for connecting to a rope of a rodeo contestant, and a conductive surface on the connector;
wherein detection of the end event includes:
the rope pulling on the connector when the rope is pulled taut;
the connector pulling the connector with the conductive surface out away from the electrical contacts; and
the saddle sensor identifying a time the electrical connection between the conductive surface and the one or more electrical contacts is lost.
